(19) United States
(12) Patent Application Publication
(10) Pub. No.: US 2011/0289081 A1
(43) Pub. Date: Nov. 24, 2011

(54) RESPONSE RELEVANCE DETERMINATION FOR A COMPUTERIZED INFORMATION SEARCH AND INDEXING METHOD, SOFTWARE AND DEVICE

(75) Inventor: Andra Willits, Woodstock (CA)

(73) Assignee: IntelliResponse Systems Inc.

(21) Appl. No.: 12/783,601

(22) Filed: May 20, 2010

(51) Int. Cl. G06F 17/30

(52) U.S. Cl. 707/728; 707/E17.014; 707/769

(57) ABSTRACT

In a computer implemented method, a plurality of Boolean expressions are stored, and one of the plurality of Boolean expressions is associated with each of a plurality of possible responses. Each of the plurality of Boolean expressions identifies at least one condition to be satisfied by a text query, to which its associated one of the plurality of responses is to be provided. In response to a provided query a response is returned. Text of the provided query is compared to the text of a returned response to determine a measure of relevance of the returned response.

### FIELD OF THE INVENTION

The present invention relates to the indexing of information, and more particularly to a method, software and devices for searching retrieving information using a computer, and for verifying the relevance/quality of the retrieved information.

### BACKGROUND OF THE INVENTION

U.S. Pat. No. 7,171,409, the contents of which are hereby incorporated by reference, discloses an information search and indexing method in which information is organized as plurality of responses to possible queries. For each response, a Boolean expression that may be applied to possible queries is formulated and stored. When a query is received, the stored Boolean expressions are applied to the query. Responses associated with the expressions that are satisfied by the query may be presented.

As disclosed in the '409 patent, each Boolean expression needs to be carefully formulated so that a query for an associated response satisfies the expression, without satisfying Boolean expressions associated with other responses.

In this way, and in contrast to conventional query and indexing methods, the actual contents of responses and the expected queries may be entirely independent.

Designing a collection of Boolean expressions for the plurality of responses is challenging. Each Boolean expression should only be satisfied by an expected query for the response associated with the expression. The difficulty is compounded as responses are added to an existing collection of responses. Generally, the more responses that form part of an information base, the more difficult the formulation of new Boolean expressions becomes.

Accordingly, there remains a need to be able to improve the accuracy of returned responses.

### SUMMARY OF THE INVENTION

Exemplary of embodiments of the present invention, a plurality of Boolean expressions are stored, and one of the plurality of Boolean expressions is associated with each of a plurality of possible responses. Each of the plurality of Boolean expressions identifies at least one condition to be satisfied by a text query, to which its associated one of the plurality of responses is to be provided. In response to a provided query, a response is returned. Text of the provided query is compared to the text of a returned response to determine a measure of relevance of the returned response.

In accordance with an aspect of the present invention, there is provided a computer implemented method of providing a response to a user comprising: storing a plurality of possible responses; storing a plurality of Boolean expressions, one of the plurality of Boolean expressions associated with each of the plurality of possible responses, each of the plurality of Boolean expressions identifying at least one condition to be satisfied by a text query, to which its associated one of the plurality of responses is to be provided; receiving a text query; for each of the plurality of possible responses, applying its associated Boolean expression to the received text query thereby determining if the associated Boolean expression is satisfied by the text query; presenting at least one of the plurality of possible responses, in response to the determining; and comparing text of the query to the text of the at least one response to determine a measure of relevance of the at least one response.

In accordance with another aspect of the present invention, there is provided a computer readable storage medium, storing computer executable software, that when loaded at a computing device in communication with a stored plurality of responses, and a plurality of Boolean expression each associated with one of the responses and to be satisfied by an appropriate query for an associated response, adapt the computing device to: store a plurality of possible responses; storing a plurality of Boolean expressions, one of the plurality of Boolean expressions associated with each of the plurality of possible responses, each of the plurality of Boolean expressions identifying at least one condition to be satisfied by a text query, to which its associated one of the plurality of responses is to be provided; receive a text query; for each of the plurality of possible responses, applying its associated Boolean expression to the received text query thereby determining if the associated Boolean expression is satisfied by the text query; present at least one of said plurality of possible responses, in response to the determining, and compare text of the query to the text of the at least one response to determine a measure of relevance of the at least one response.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 illustrates a computer network and network interconnected server, operable to index information and provide search results, exemplary of an embodiment of the present invention;

FIG. 2 is a functional block diagram of software stored and executing at the network server of FIG. 1;

FIG. 3 is a diagram illustrating a database schema for a database used by the network server of FIG. 1;

FIG. 4 illustrates an exemplary response, associated contemplated queries and associated Boolean expressions;

FIGS. 5 and 6 illustrate exemplary steps performed at the server of FIG. 1;

FIG. 7A-7B and 8A-8D illustrate steps performed in order to assess response relevance in manners exemplary of embodiments of the present invention; and

FIG. 9 is a flow chart illustrating calculation of a relevance score, exemplary of embodiment of the present invention.

### DETAILED DESCRIPTION

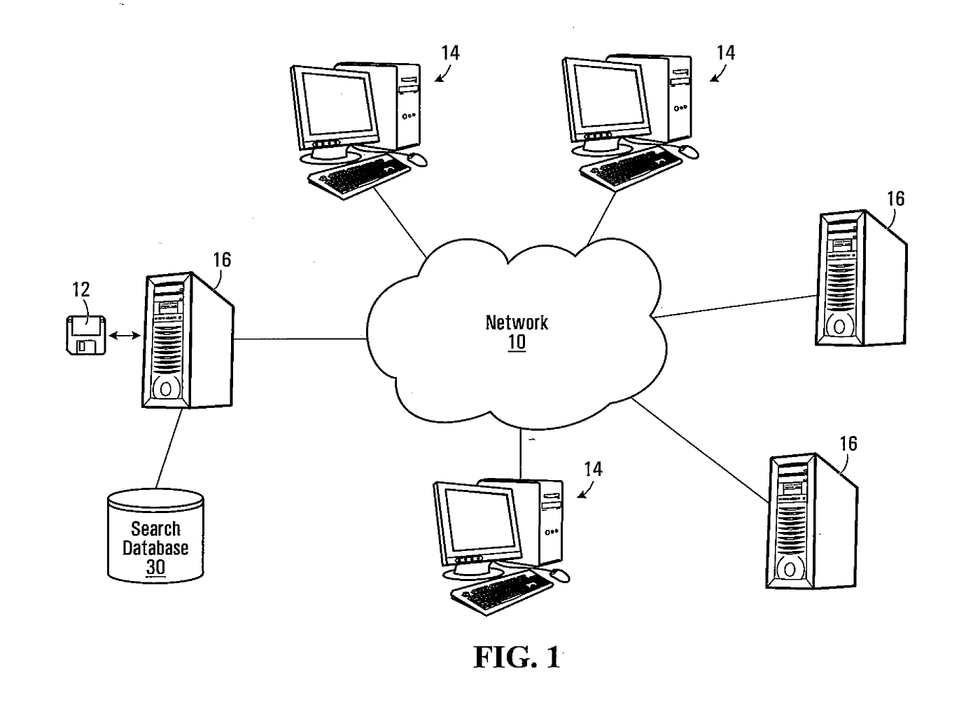

FIG. 1 illustrates a computer network interconnected server 16. Server 16 which may be a conventional network server, that is configured and operates largely as described in the '409 Patent, and in manners exemplary of embodiments of the present invention as detailed herein.

As illustrated, server 16 is in communication with a computer network 10 in communication with other computing devices such as end-user computing devices 14 and computer servers 18. Network 10 may be a packet switched data network coupled to server 16. So, network 10 could, for example, be an Internet protocol, X.25, IPX compliant or similar network.

Example end-user computing devices 14 are illustrated. Servers 18 are also illustrated. As will become apparent, end-user computing devices 14 are conventional network interconnected computers used to access data from network interconnected servers, such as servers 18 and server 16.

Example server 16 preferably includes a network interface physically connecting server 16 to data network 10, and a processor coupled to conventional computer memory. Example server 16 may further include input and output peripherals such as a keyboard, display and mouse. As well, server 16 may include a peripheral usable to load software exemplary of the present invention into its memory for execution from a software readable medium, such as medium 12.

As such, server 16 includes a conventional file-system, typically controlled and administered by the operating system governing overall operation of server 16. This file-system may host search data in database 30, and search software exemplary of an embodiment of the present invention, as detailed below. In the illustrated embodiment, server 16 also includes hypertext transfer protocol (“HTTP”) files; to provide end-users an interface to search data within database 30. Server 16 stores index information and provides search results to requesting computing devices, such as devices 14.

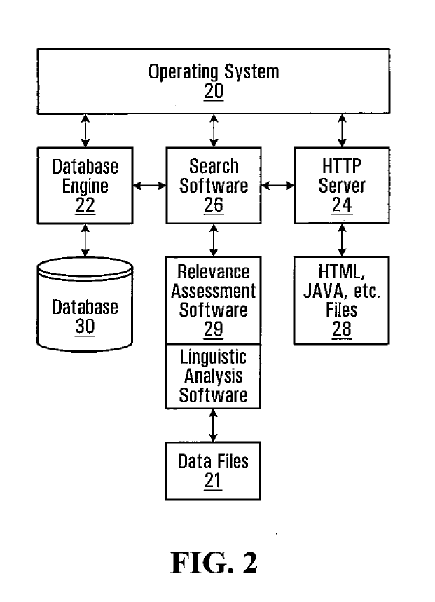

FIG. 2 illustrates a functional block diagram of software components preferably implemented at server 16. As will be appreciated, software components embodying such functional blocks may be loaded from medium 12 (FIG. 1) and stored within persistent memory at server 16. As illustrated, software components preferably include operating system software 20; a database engine 22; an http server application 24; and search software 26, exemplary of embodiments of the present invention. Further, database 30 is again illustrated. Again database 30 is preferably stored within memory at server 16. As well data files 28 used by search software 26 and http server application 24 are illustrated.

Additionally server 16 may include relevance assessment component 29, which may include software exemplary of embodiments of the present invention, as well as linguistic analysis software as described below. Linguistic analysis software may include General Architecture for Text Engineering (GATE) components (available at http://gate.ac.uk/); WordNet from Princeton University; MorphAdorner parts of speech tagger from Northwestern University. Data files 31 used by assessment component 29 are also illustrated.

Operating system software 20 may, for example, be a Linux operating system software; Microsoft NT, XP Vista, operating system software, or the like. Operating system software 20 preferably also includes a TCP/IP stack, allowing communication of server 16 with data network 10. Database engine 22 may be a conventional relational or object oriented database engine, such as Microsoft SQL Server, Oracle, DB2, Sybase, Pervasive or any other database engine known to those of ordinary skill in the art. Database engine 22 thus typically includes an interface for interaction with operating system software 20, and other application software, such as search software 26. Ultimately, database engine 22 is used to add, delete and modify records at database 30. HTTP server application 24 is preferably an Apache, Cold Fusion, Netscape or similar server application, also in communication with operating system software 20 and database engine 22. HTTP server application 24 allows server 16 to act as a conventional http server, and thus provide a plurality of HTTP pages for access by network interconnected computing devices. HTTP pages that make up these home pages may be implemented using one of the conventional web page languages such as hypertext mark-up language (“HTML”), Java, javascript or the like, these pages may be stored within files 28.

Search software 26 adapts server 16, in combination with database engine 22 and operating system software 20, and HTTP server application 24 to function as described in the '409 patent. Search software 26 may act as an interface between database engine 22 and HTTP server application 24 and may process requests made by interconnected computing devices. In this way, search software 26 may query, and update entries of database 30 in response to requests received over network 10, in response to interaction with presented web pages. Similarly, search software 26 may process the results of user queries, and present results to database 30, or to users by way of HTTP pages. Search software 26 may for example, be suitable CGI or Perl scripts; Java; Microsoft Visual Basic application, C/C++ applications; or similar applications created in conventional ways by those of ordinary skill in the art.

HTTP pages provided to computing devices 14 in communication with server 16 typically provide users at devices 14 access to a search tool and interface for searching information indexed at database 30. The interface may be stored as HTML or similar data in files 28. Conveniently, information seekers may make selections and provide information by clicking on icons and hyperlinks, and by entering data into information fields of the pages, presented at devices 14. As such, HTTP pages are typically designed and programmed by or on behalf of the operator or administrator of server 16. Conveniently, the HTTP pages may be varied as a server, like server 16, is used by various information or index providers.

Likewise, relevance assessment component 29, exemplary of embodiments of the present invention may be software written using a general purpose programming language, such as Java, C, C+ PERL; or the like. An additional graphical user interface may optionally be provided using HTML, JSP, Javascript, or the like. Conveniently, component 29 may be in communication with search software 26 and data base engine 22 (and thus database 30) to receive queries received by search software 26, and the output from search software 26. A person of ordinary skill will readily appreciate that component 29 need not be hosted at server 16, but could easily be hosted by another computing device in communication with server 16, for example by way of network 10. Data files 31 may store data for use by component 29, as detailed below

Files 28 and search software 26 may further define an administrator interface, not specifically detailed herein. The administrator interface may allow an administrator to populate database 30, and retrieve data representative of user queries, as detailed below. The administrator interface may be accessed through network 10, by an appropriate computing device using an appropriate network address, administrator identifier and password. Optionally, component 29 may include an administrator interface allowing the viewing of results produced by component 29.

The architecture of computing devices 14 (FIG. 1) is not specifically illustrated. Each of devices 14 (FIG. 1), however, may be any suitable network aware computing device in communication with data network 10 and capable of executing a suitable HTML browser or similar interface. Each computing device 14 is typically provided by an end-user and not by the operator of server 16. Computing devices 14 may be conventional desktop computers including a processor, network interface, display, and memory. Computing devices 14 may access server 16 by way of data network 10. As such, each of devices 14 typically stores and execute network aware operating systems including protocol stacks, such as TCP/IP stack, and internet web browsers such as Microsoft Internet Explorer™, Mozilla™, or Opera™ browsers.

As noted, server 16 includes a database 30. Database 30 is preferably a relational database. As will become apparent, database 30 includes records representative of index data that may be considered the knowledgebase indexed within database 30. Database 30 may further store information representative of searches requested through server 16.

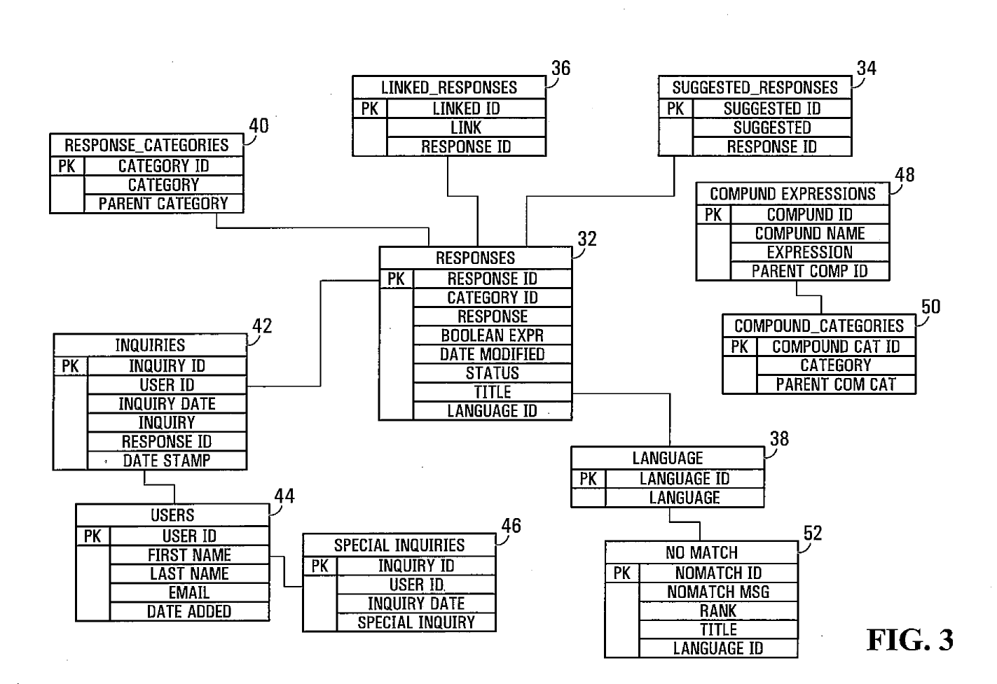

A simplified example organization of database 30 is illustrated in the '409 patent. A simplified example organization of database 30 is illustrated in FIG. 3. As illustrated, example database 30 is organized as a plurality of tables. Specifically, database 30 includes responses table 32 (RESPONSES), suggested responses table 34 (SUGGESTED_RESPONSES); linked responses table 36 (LINKED_RESPONSES); languages table 38 (LANGUAGE); response categories table 40 (RESPONSE_CATEGORIES); inquiries table 42 (INQUIRIES); users table 44 (USERS); special inquiries table 46 (SPECIAL_INQUIRIES); compound expressions table 48 (COMPOUND_EXPRESSIONS); compound categories table 50 (COMPOUND_CATEGORIES); and no match table 52 (NO_MATCH).

Of note, response table 32 includes a table entry for each indexed response. Each table entry includes a field RESPONSE—containing full text (or a link thereto) to the full text of an indexed response. As well, each entry of table 32 includes an entry BOOLEAN EXPR. identifying a Boolean expression that should be satisfied by an expected query for the response contained within the entry of table 32. Expressions contained in BOOLEAN EXPR. for the various table entries in table 32 are applied to identify matching responses. Of additional note, each response entry includes an associated TITLE field that contains text succinctly identifying the nature of the response that has been indexed. The TITLE field may contain a conventional title or abstract, or any other succinct, relevant summary of the contents of the RESPONSE field of the entry.

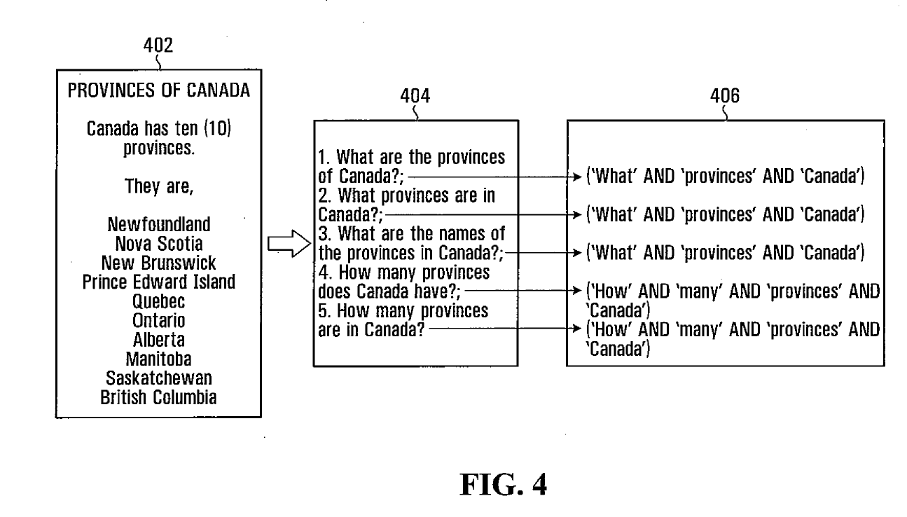

To better appreciate use of server 16 and database 30, FIG. 4 illustrates an example response 402 to be indexed for searching by server 16. Specifically, example response 402 may be data in any computer understandable form. For example, response 402 could be text; audio; an image; a multimedia file; an HTML page. Response 402 could alternatively be one or more links to other responses. For example, response 402 could simply be a hypertext link to information available somewhere on network 10, (for example at one of servers 18). Response 402 may be associated with a plurality of queries 404, which are anticipated to be satisfied by response 402. That is, response 402 when presented by a computer in a human understandable form provides a satisfactory answer to a user presenting any one of queries 404.

The queries are preferably plain text queries. For illustration only, illustrated response 402 is a text representation of Canadian provinces, and an introduction to these provinces. Typical queries 404 for which response 402 is satisfactory are also depicted and may include 1. “What are the provinces of Canada?”; 2. “What provinces are in Canada?”; 3. “What are the names of the provinces of Canada?”; 4. “How many provinces does Canada have?”; and 5. “How many provinces are in Canada?.

Queries 404 in turn may be used to form one or more Boolean expressions 406, containing one or more terms satisfied by the queries. The Boolean expressions may be manually formulated by noting the important words/phrases in each query. For example, queries 1. and 2. satisfy the Boolean expression (‘What’ AND ‘provinces’ AND ‘canada’) and query 3. satisfies the Boolean expression (‘*name’ AND ‘provinces’ AND ‘canada’); queries 4 and 5 both satisfies the Boolean expression (‘How’ AND ‘many’ AND ‘provinces’ AND ‘Canada’.

So, queries 1, 2, 3, 4, and 5 may be represented by a single, multi-term Boolean expression: (‘What’ AND ‘provinces’ AND ‘Canada’) OR (‘What’ AND ‘provinces’ AND ‘Canada’) OR (‘name*’ AND ‘provinces’ AND ‘Canada’) OR (‘How’ AND ‘many’ AND ‘provinces’ AND ‘Canada’) OR (‘How’ AND ‘many’ AND ‘provinces’ AND ‘Canada’).

At the same time, many questions about Canada's provinces, however, are not answered by response 402. For example, queries like 6. “What is the largest province in Canada?”; and 7. “What is the eastern-most province in Canada?”; and the like are not answered by response 402, and are therefore not illustrated among queries 404.

As such, these queries could be explicitly excluded by Boolean expression 406. For reasons that will become apparent, if responses specifically addressing queries 6. and 7. are stored and indexed within table 32, explicit exclusions of the identified Boolean expressions may be unnecessary.

Boolean expression 406, once appropriately formulated is stored within database 30, in the BOOLEAN_EXPR field of table 32 storing response 402. The actual response in a computer understandable format is also stored within the associated record in table 32. Queries 404, themselves may also be stored in inquiries table 42. Similar Boolean expressions are developed for other responses indexed by database 30, and stored in table 32. Formulation of a suitable queries and resulting Boolean expressions for each response are typically performed manually. Each record within table 32 stores a response and associated Boolean expression.

Preferably, an administrator also considers which other responses a user seeking a particular (i.e. primary) response within table 32 may be interested in. Suggested response table 34 may be populated by the administrator with identifiers of such other suggested responses. Each other suggested response is identified in table 34 by a suggested response identifier (in the SUGGESTED_ID field), and linked to a primary response in table 32. So for the example response 402, suggested responses may answer queries such as “What are the capitals of the provinces?”; “What are the territories of Canada?”, and the like.

Additional responses may also be incorporated by reference in a particular response. Such additional responses may be presented in their entirety along with a sought response in table 32. References to the additional responses are stored in table 34 (in SUGGESTED field), with a reference to a primary response in table 32 (stored in the REPSONSE_ID field).

In the preferred embodiment, database 30 is populated with Boolean expressions representative of natural language queries. As such, the interface provided to the end-user preferably indicates that a natural language query is expected. Of course, Boolean expressions could be formulated for other queries having a syntax other than a natural language could readily be formulated.

Server 16 accordingly is particularly well suited for indexing a single network site, operated by a single operator who is capable of and willing to consider appropriate anticipated queries; Boolean expressions; and related/suggested responses. The operator may further tailor the contents of the web site to logically separate the content of responses, bearing in mind queries to be answered by each response.

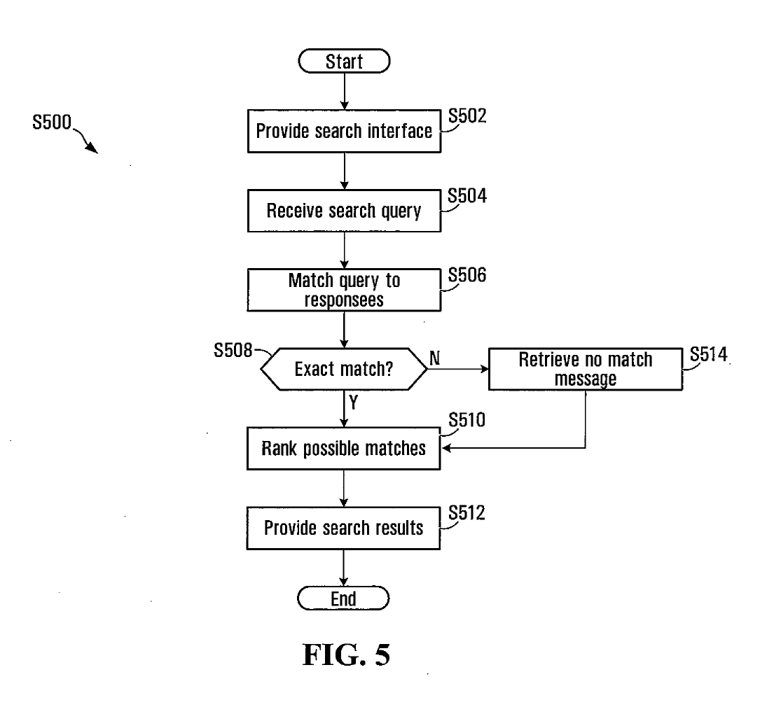

In operation, a user at a computing device interconnected with network 10 contacts server 16 containing an index of responses and Boolean expressions satisfied by possible queries, formed as detailed above. In response steps S500 and onward illustrated in FIG. 5 are performed at server 16. Optionally, prior to the performance of steps S500 the user's identity may be prompted or retrieved. Specifically, sufficient information used to populate or retrieve a record in table 44 may be obtained from the user. That is, the user could be prompted for a name, a persistent state object (“cookie”) could be retrieved from the user's computer, or the like. As will become apparent, knowledge of the user's identity although advantageous, is not required.

In any event once, server 16 is used to allow user queries, server 16 provides a search interface, typically in the form of an HTML page to the contacting computing device 14 in step S502. The HTML page includes a search field. This search field may be populated with a desired query by the user. The interface may further provide the user with suitable instructions for entering an appropriate query.

Next, a query is received at server 16 in step S504. Optionally, particulars about the query may be logged in inquiries table 42. In response to receiving the query, software 26 parses words within the query (QUERY) and applies Boolean expressions stored within the BOOLEAN_EXPR field of table 32 for all (or selected) responses stored in table 32. In parsing, extra spaces and punctuation in the query are preferably removed/ignored. Unlike typical search techniques, submitted queries are not used to form Boolean expressions used to search responses. Instead, stored Boolean expressions for indexed responses are applied against submitted queries.

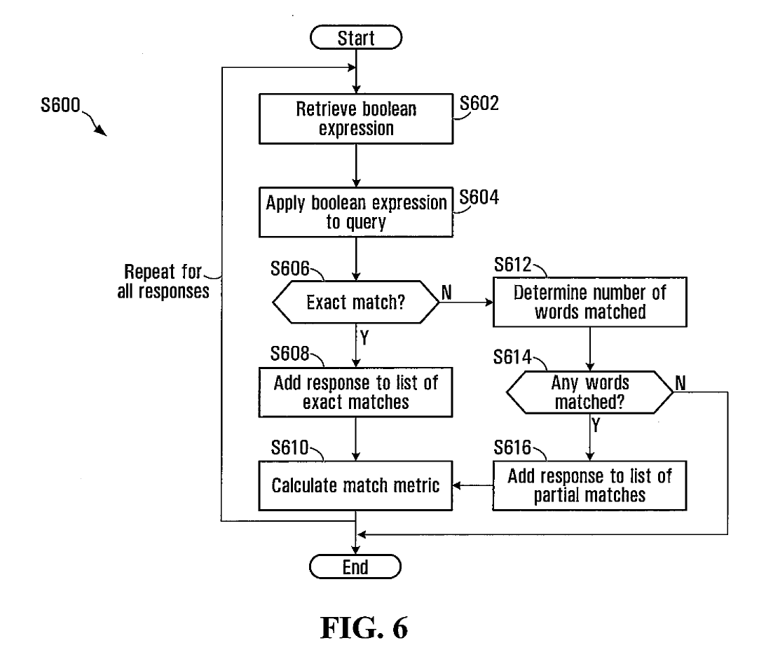

So, for each Boolean expression in table 32, steps S600 of FIG. 6 are performed in step S506. That is, in step S602 the Boolean expression stored in each BOOLEAN_EXPR field of table 32 is applied to the received query, and is evaluated. In the example embodiment, each term of a stored Boolean expression is separately by a Boolean operator and separately evaluated. Strings are encased with single quotes, and matched without regard to case. Logical operators AND, OR, NOT, XOR and the like may separate terms and may be interpreted. Similarly, common wild cards such as “*”, “?” and the like may be used as part of the expressions. Common Boolean terms may be represented as single terms. Compound terms forming part of a Boolean expression may be identified with a special character such as square brackets. Compound terms are defined in tables 50 and 52 and separately evaluated as detailed below.

As will be appreciated, many Boolean expressions are equivalent. As such, server 16 under control of software 26 may reduce the Boolean expression to a canonical form, having multiple unique terms ORed together. That is, any Boolean expression is reduced to a format (sub-expression1) OR (sub-expression2) OR (sub-expression3) OR (sub-expresion 4).

In this format, the Boolean expression will be satisfied if any one of the multiple sub-expressions is satisfied. Each of the ORed sub-expressions, in turn includes a single term or multiple terms that are ANDed together. Each term could, of course be a NOT term. In this way any Boolean expression may be canonically represented.

Conveniently, in this canonical format, a degree of match for each sub-expression, and for the entire Boolean expression may easily be calculated in a number of ways.

For example, as each sub-expression (i.e. sub-expression1, sub-expression 2 . . . ) includes only terms that are ANDed together, it is possible to calculate a degree of match for each sub-expression, as the ratio of the total number of terms in the sub-expression that are satisfied by the query, to the total number of terms of the sub-expression in the query. Thus the degree of match for any matched sub-expression would be one (1).

So for example, if sub-expression1=(A AND B AND C), a first query including words A, B and C would satisfy sub-expression1. A second query including only words A and B would not satisfy sub-expression1. A degree of match equal to 2/3 could be calculated for sub-expression1 as applied to this second query.

At the same time, in the event a sub-expression is satisfied by the query, a quality of match for that sub-expression may be calculated. Again, a quality of match may be calculated in any number of ways. For example, the quality of match may be calculated as the ratio of the number of terms in a sub-expression, divided by the total number of words in the query. So a five (5) word query including the words A, B, and C, would satisfy sub-expression1 and a quality of match equal to 3/5 could be calculated.

So, in the event a Boolean expression is satisfied by the words of the submitted query, as determined in step S606, an identifier for the response associated with the satisfied Boolean expression is maintained in step S608. As well, one or more metrics identifying the quality of the match may be calculated in step S610.

Numerous other ways of determining metric(s) indicative of a degree of match will be appreciated by those of ordinary skill in the art.

This metric(s) may be calculated in any number of ways. As noted the quality of match for the Boolean expression may be calculated, by calculating the quality of match for any of the matched sub-expression of the Boolean expression, and choosing the largest of these as calculated. For the example Boolean expressions 404 (FIG. 4), question 1. “How many provinces are in Canada”, would produce an exact match and a quality of match score of 4/6, calculated as above. A question of “How many provinces in Canada are east of Saskatchewan” would yield an exact match with a quality of match word score of 4/9. The largest of these calculated word scores may be considered the quality of match metric for the Boolean expression as applied to the particular query.

Optionally, additional metrics indicative of the quality of match may be calculated. For example, a further “relevant” word score, may be calculated by calculating a quality of match once common (or “irrelevant”) words stored in a common word dictionary (not specifically illustrated) are excluded. For example words like “the”, “in”, “an”, etc. in the query may be excluded. The dictionary of irrelevant words may be manually formed depending on the responses stored within table 34. Other metrics indicative of the quality of match could be calculated in any number of ways. For example, each term in a Boolean expression could be associated with a numerical weight; proximity of matched words in the query could be taken into account. Other ways of calculating a metric indicative of a quality of match may be readily appreciated by those of ordinary skill in the art.

In the event a Boolean expression does not result in an exact match, as determined in step S606, the number of matched words within the Boolean expression may be determined in step S612. If at least one word is matched to a term in any sub-expression, as determined in step S614, the response may be noted as a partially matched response in a list of partially matched responses in step S616. A metric indicative of the degree of match may be calculated for the Boolean expression in step S610. For example, a degree of match, as detailed above, may be calculated for each sub-expression of the Boolean expression. The largest of these may be stored as the degree of match for the query. Thus, an identifier of the partially satisfied response and the ratio of matched terms to total terms may also be stored in step S616. Steps S602 and onward are repeated for each response within database 30.

Once all exactly and partially matched responses are determined in step S506 (i.e. steps S600), the best exact match, if any (as determined in step S508) is determined in step S510. The best exact match may be the exact match determined in steps S600 having the highest metric [e.g. word count and/or relevant word count, etc.]. In step S510, other exact response may be ranked. Similarly, partial matches may be ranked using the calculated degree of match metric. In step S512, the best exactly matched response is obtained from the RESPONSE field of table 32 and presented. As well, any linked responses (i.e. data in the RESPONSE field) as identified in table 36 are also presented. Preferably, the best matched exact response is unique. If it is not, all exact matches with equal degrees of matches may be displayed. As well as titles (or links) of stored associated and suggested responses stored in tables 34 and 36 are presented. These may, for example, be presented in a drop down box, or the like. Similarly, if server 16 indexes other types of data in table 32, (e.g. sound, images, etc.), the data associated with the best matched response may be presented in human understandable form. Preferably, not all partially matched responses will be presented. Instead only a defined number of responses or responses whose other metrics exceed defined scores need be presented. Title of these may also be presented in a drop-down box.

Results, including the highest ranked exact response, possible alternate responses, and responses associated with the highest ranked response are preferably presented to a computing device of the querying user in step S510. Results may be presented as an HTML page, or the like.

In the event no exact match is found, as determined in step S508, a message as stored in NO_MATCH table 52 indicating that no exact match has been found is retrieved in step S514. Partial matches, if any, are still sorted in step S510. A result indicating no exact match and a list of partial matches is presented in step S512.

Optionally, in the event no exact match is determined, the user may be prompted to rephrase his query or submit this query as a special query for manual processing. This may be accomplished by presenting the user with an HTML form requesting submission of the query as a special query for later handling by the administrators of server 16. If the user chooses to do so, the query for which no exact match is obtained may be stored in table 52. At a later time, an administrator of server 16 may analyze the query, and if desirable update responses and/or Boolean queries stored in table 32 to address the special query. If a userid is associated with the special query, a conventional reply e-mail addressing the special query may be sent to user.

After a single query is processed, steps S500 and onward may be repeated and additional queries may be processed.

Additionally, once response(s) for queries has/have been identified, the relevance or quality of the responses may be further assessed by matching the query to the contents of actual response for which associated Boolean expression have been satisfied by the query, in manners exemplary of embodiments of the present invention. The relevance of responses may be assessed in batches, or after each response has been identified.

In particular, the quality of a response to a query may be assessed by relevance assessment component 29 (FIG. 2),
(i) matching the query to the title of the response;
(ii) perform a semantic analysis to compare the query to the title of the response;
(iii) perform a linguistic analysis to compare the query to content of the response.

Each or all of these relevance assessments may be performed as detailed below, for the best matching response/query combination to calculate a relevance/quality of response score for each response. In this way, matching responses with a particularly low quality of match/relevance score may be identified to allow an administrator to review the query, the response, and the Boolean expression associated with the response. Conveniently, the response of interest, (RESPONSE), or a pointer thereto and the text of the query (QUERY), or a pointer thereto, may be passed to component 29.

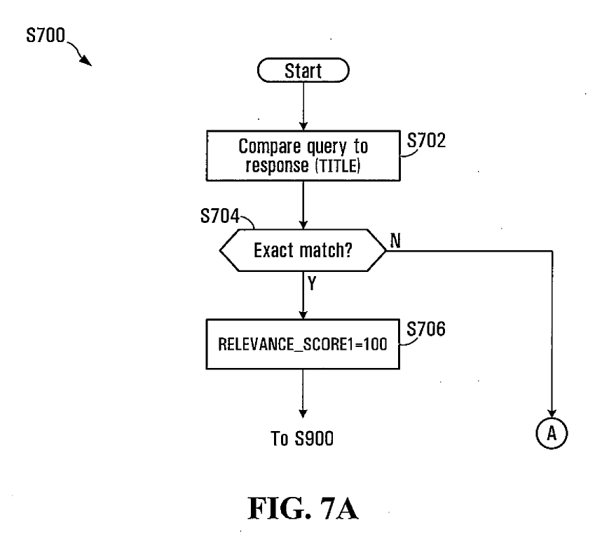

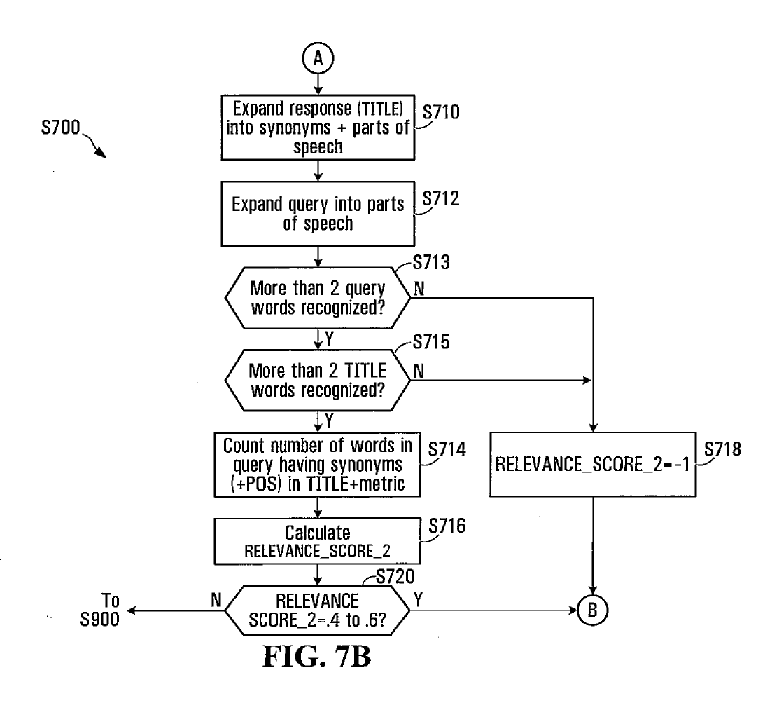

In particular, blocks S700 (FIGS. 7A and 7B) may be performed. As illustrated, in blocks S702 the query (QUERY) is simply compared word for word, with the title or abstract field (TITLE) of the matched response (vis. FIG. 4, table 32—field TITLE). If the title matches the query as determined in block S704, a score of 100 showing a near ideal match may be assigned to RELEVANCE_SCORE_{—}1 in block S706, and the assessment may terminate, and blocks S900 may be performed. Otherwise, additional relevance scores may be calculated, as described below. The value of RELEVANCE_SCORE_{—}1 may retain its initial value (i.e. 0).

In the event the query does not match the title exactly, a semantic comparison of the query and the title is performed in an effort to assess if the meanings of the title and query are similar or related. Specifically, the string in the title field (TITLE) is expanded into synonyms in block S710, and the query (QUERY) is then compared to the expanded title.

More specifically, in block S710 each word of the title field (TITLE) is expanded into possible synonyms using an synonym dictionary like WordNet from Princeton University, as well the parts of speech of each word within the title are assessed. In the event that too few words of the title are found in the dictionary (i.e. less than two words in the title of the response, or the query are found in the dictionary), as determined in blocks S713, S715, the semantic analysis may be terminated. Prior to termination, a value of −1 may be assigned to the variable RELEVANCE SCORE_{—}2 in block S718.

The parts of speech of each word in the title field may be determined using a linguistic analysis tool—like a component of the GATE, the MorphAdorner parts of speech tagger (available from Northwestern University) or the like. In block S712 the synonyms and parts of speech for each word in the query (QUERY) may also be assessed. In block S716 the words of the title field may be compared to the expanded form of the query.

More specifically the number of words whose synonyms are found in the title field and the query, along with corresponding parts of speech may be counted. A distance metric may be assessed for each matched word. The distance metric may be based on a bipartite graph.

For example,

Query: What are your fees (Noun)?
Fees (N):
   Definition: a fixed charge for a privilege or for professional services Synonyms: account, ante, bill, bite, chunk, commission, compensation, consideration, cost, cut, emolument, end, expense, gravy, handle, hire, honorarium, house, juice, pay, payment, percentage, piece of the action, piece, price, rake-off, recompense, remuneration, reward, salary, share, slice, stipend, take, take-in, toll, wage

Response Title: How much is tuition (Noun)?
Tuition (N):
   Definition: a fee paid for instruction (especially for higher education) Synonym: charge, expenditure, fee, instruction, lessons, price, schooling, teaching, training, tutelage, tutoring

This simple example shows that although the query and response title share no common words, the meaning of the nouns in both strings have definition and synonym commonalities. For example, the word tuition has fee as a synonym and fee also occurs in the definition of tuition.

The semantic score may be calculated in block S716 using mathematical models including Bipartite Graphs and Edit Distance calculations that determine how similar the definitions of the words in the query and the words in the response title are.

For example, the title field and query may be broken down into a list of each word in the string. The dictionary may then be checked to confirm that it contains at least two words in the query and two words in the response. If not, the analysis returns a score of −1 and terminates, moving onto the linguistic analysis. If there are at least two words, for each word in the query, the part of speech, and then the WordNet instance of the word are determined. All the relations and definitions of each word are determined from the WordNet dictionary. This may include not only the definition but also synonyms, hypernyms, hyponym, holonym, meronym and verb groups.

Since there are potentially many definitions of a given word, the list of definitions for a given word may be trimmed. All definitions may be searched, comparing to other words, their definitions and relations in the query to determine the most likely meaning for each word in context. This returns the best contextual definition for each word in the query.

This is then repeated for the response title. At this point two lists have been formed, one containing a definition and relations for each word in the query and one containing a definition and relations for each word in the response title.

For each word in the query, each element in the response title is compared. This may be done by calculating the similarity between the two definition strings using edit distance.

The edit distance between two strings, for example, is a common method used in computational linguistics and is typically understood as: the number of operations required to transform one string into the other. In this case, the variation of edit distance used is the Levenshtein distance. The Levenshtein distance between two strings is given by the minimum number of operations needed to transform one string into the other, where an operation is an insertion, deletion, or substitution of a single character.

For example, the Levenshtein distance between “kitten” and “sitting” is 3, since at least three edits are required to change one into the other (substitution of ‘s’ for ‘k’; substitution of ‘i’ for ‘e’; and insertion of ‘g’ at the end.

This can be applied on a larger scale which is done in this case for each definition of each word in the query and response title to determine how many steps between the meaning of each word in the query and response title.

Once this is complete, a Bipartite Graph may be used to compute the semantic similarity of the two strings as a whole. This may be modelled as a problem of computing a maximum total matching weight of a bipartite graph where X and Y are two sets of disjoint nodes. As will be apparent, in Bipartite graphs there are no arcs between a concept and another concept, no arcs between a relation and another relation. The nodes of a bipartite graph can thus be divided into two non-empty sets A and B, with two different kinds of nodes. All arcs of a bipartite graph then connect exactly one node from A and one node from B. Therefore all arcs cross the boundary between the two sets of the two kinds of nodes.

Bipartite graphs are useful for modelling matching problems. An example of bipartite graph is a job matching problem. Suppose we have a set P of people and a set J of jobs, with not all people suitable for all jobs. We can model this as a bipartite graph (P, J, E). If a person px is suitable for a certain job jy there is an edge between px and jy in the graph. The marriage theorem provides a characterization of bipartite graphs which allow perfect matchings.

So, such a graph may model each matching meaning between the query and response as an edge of the graph. A list of meanings that were matched on the graph may then be returned and a metric may be calculated using the results. For example, 2*Match(X,Y)/|X|+|Y| where match (X,Y) are the matching word tokens between X and Y. Divide the sum of similarity values of all match candidates of both sentence X and Y by the total number of tokens. This final score will be between 0 and 1 and may be returned as RELEVANCE_SCORE_{—}2.

The score is a cumulative—each word and definition are looked at in turn and a final score, RELEVANCE_SCORE_{—}2, is calculated having a value between 0 and 1. The closer to 1 the more semantically similar the two strings are.

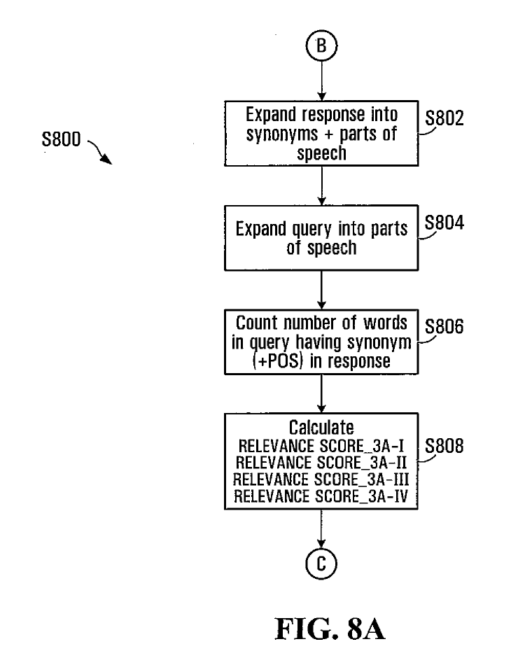

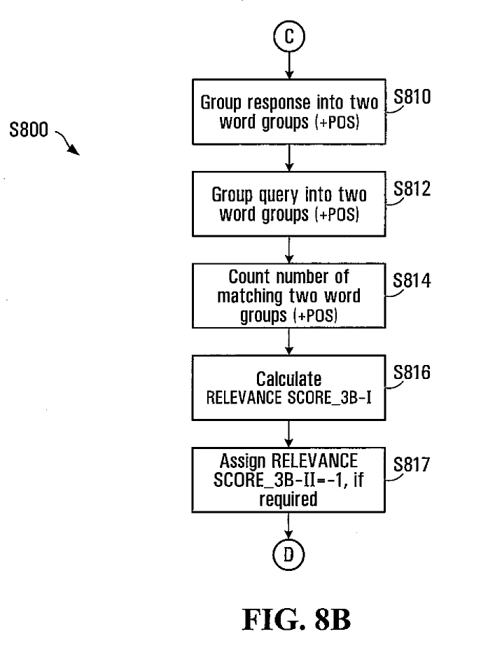

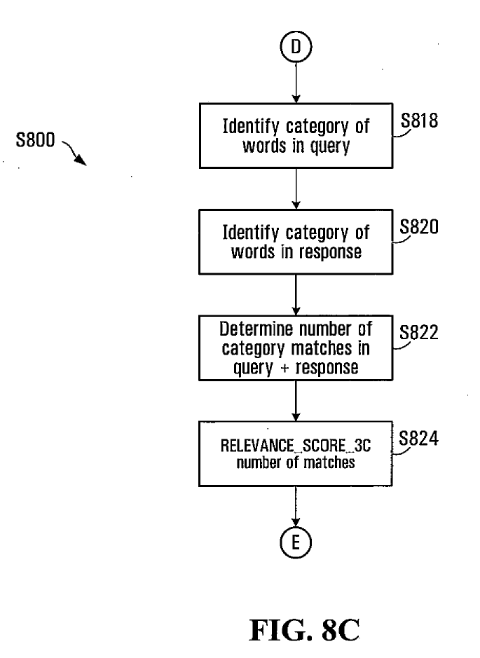

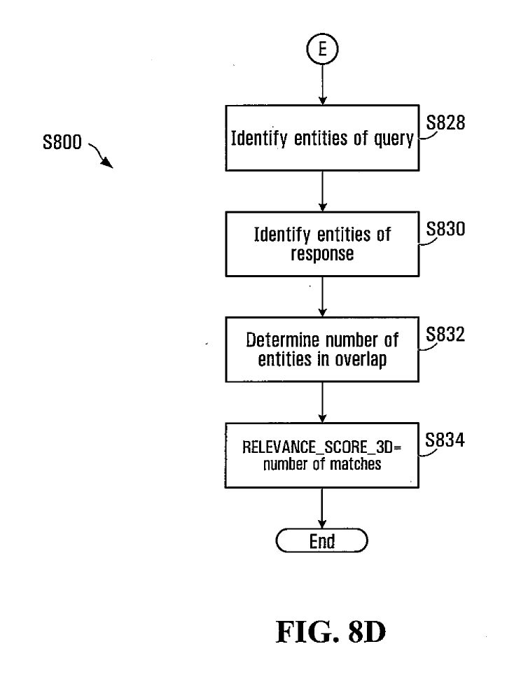

If the calculated semantic score, RELEVANCE_SCORE_{—}2, is not conclusive (e.g. between 0.4 and 0.6) as determined in block S720, a comparison of the query (QUERY) to the entire response may be performed to determine the overlap between the response and query as illustrated in blocks S800 (FIGS. 8A-8D).

The overlapping word could be an original word or a synonym of an original word in the query that overlaps with a word in the response. Four separate counts may be performed. The response need not be expanded into synonyms.

Specifically, in block S802, each word within the query (QUERY) is processed to determine its synonyms and its part of speech. Next, in block S804 the part of speech each word in the response (as contained in the RESPONSE field) is determined. Again, WordNet, GATE, MorphAdorner or similar utilities may be used to determining synonyms and parts of speech. Then, each word in within the query (QUERY) and its synonyms is matched to the words in the response to determine if the word is present, and if its part of speech is the same as in the question.

The number of matching words may be counted in block S806. Specifically, the number of nouns that overlap in the query and response may be calculated (RELEVANCE_SCORE_{—}3A-I); the number of verbs that overlap in the query and response (RELEVANCE_SCORE_{—}3A-II); and the number of adjectives that overlap in the query and response (RELEVANCE_SCORE_{—}3A-III). The total number of words that overlap in the query and response is simply a total of the three previous counts (RELEVANCE_SCORE_{—}3A-IV).

Score of the match RELEVANCE_SCORE_{—}3A-I, RELEVANCE_SCORE_{—}3A-II, RELEVANCE_SCORE_{—}3A-III, RELEVANCE_SCORE_{—}3A-IV may be calculated in block S808.

Additionally, in blocks S810 and S812, the text of the query (QUERY) and the text of the response (RESPONSE) is respectively parsed into two word groups: groups of two adjacent nouns, and adjective+noun groups. That is, any word pairs of the form noun+noun, and adjective+noun is extracted in blocks S810 and S812. The number of matching two word groups found in both the QUERY and the RESPONSE is counted in block S814, and a score RELEVANCE_SCORE_{—}3B-I is calculated in block S816

As well, since the presence of two word string may provide more information and relevance to a specific context, in addition to a count of the number of two word string matches in the query/response (RELEVANCE_SCORE_{—}3B-I), a second value (RELEVANCE_SCORE_{—}3B-II) signifying whether an occurrence of a two word string in the form noun+noun, adjective+noun is found at all in the response, is calculated in block S817.—If there is a string identified in the query but no matching string is found in the response, the value is set to −1, otherwise, this value is set to 0. When the final calculation is being made, as detailed below a RELEVANCE_SCORE_{—}3B-II value of −1, will cause a penalty to be applied since there was no matching string in the response. For example, a penalty of 25 may be deducted from the final relevance score if no word pair is found.

As a further form of analysis, in blocks S818-S826 any attempt is made to categorize the query, and the response. Specifically in block S818, the text of the query (QUERY) is parsed and words or groups of words are compared to terms identifying anticipated categories to which the query may relate.

This may again be performed by looking for individual words, or pairs (or triplets) of words throughout the query that signify certain query types. Example categories include: address, circumstance, consequence, contrast, definition, distance, info, ingredients, language, method, money, number, occupation, organization, person, product, promotion, rating, reason, temporal, temperature and use.

Therefore, there may be several categories in each query and in each response. Then, the number of matching categories between the two is tabulated.

In block S820 the category of the response is similarly identified. Again this may be performed by looking for individual words, or pairs (or triplets) of words throughout the response that signify certain information (e.g. the $ symbol; reference to price; etc.) The following lists illustrate the terms that might be classified in the consequence category, for queries and responses

### Example Query Phrases:

how did+affect
how did+effect
how did+result
if+affect
if+would happen
if+happen
if+happens
if+effect
if+effects
if+result
if+results
side effect
side effects
side-effect
side-effects
what+affect
what+would happen
what+happen
what+happens
what+effect
what+effects
what+result
what+results
will+affect
will+would happen
will+happen
will+happens
will+effect
will+effects
will+result
will+results

### Example Response Keywords:

affect
effect
effects
happen
happens
result
results
side-effect
side-effects
side effect
side effects
would happen

In block S822 the identified categories found in the query is compared with the category to which the response relates. A count of the number of categories between query and response may be returned as RELEVANCE_{—}3C in block S824. Otherwise a score RELEVANCE_{—}3C=0 may be assigned in block S826.

As a further form of analysis, in blocks S828-S836 the entity being queried and the entity being responded to in the response are categorized. Specifically in block S828, the text of the query (QUERY) is parsed and words are compared to terms identifying anticipated entities to which the query may relate.

Unlike the previous category overlap analysis, the entity portion only looks for a small set of question words in the query (Who, Where, When). The words listed following these question words below are the entities that are expected in the answer. The GATE Named Entity Recognition module then examines the response body and searches exhaustive lists of words within the GATE libraries for any words that occur in our response body that match and can be tagged with the correct entity: Entity pairs include Who—Person, Organization; Where—Location, Address, Organization; and When—Date.

A search for entity pairs may be performed by looking for individual words, or pairs (or triplets) of words throughout the query that signify certain query types in block S828. Example terms may identify a desired identity response (“WHO”); a temporal response (“WHEN”); a location response (“WHERE”).

In block S830 the entity of terms in the response is similarly identified. Again this may be performed by looking for individual words, or pairs (or triplets) of words throughout the response that signify certain information. For example, the response body may be examined by the GATE Named Entity Recognition tool and any Person/Organization, Location/Address/Organization, Date are tagged.

If the query has a question word that matches an entity in the response body, a count is increased by 1 to indicate a match.

In block S832 the identified entity of the query is compared with the entity to which the response relates. The number of matches may be counted, and the maintained as RELEVANCE_{—}3D in block S834.

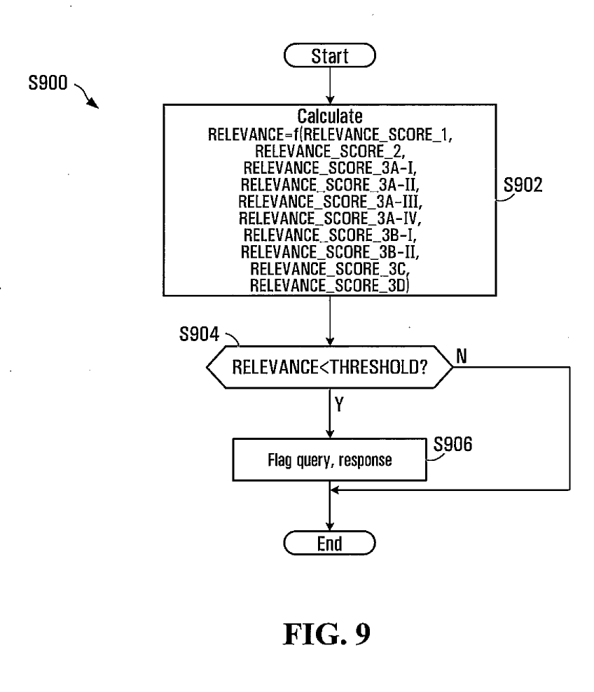

Once relevance scores (e.g. RELEVANCE_SCORE_{—}1, RELEVANCE_SCORE_{—}2, RELEVANCE_SCORE_{—}3A-I, RELEVANCE_SCORE_{—}3A-II, RELEVANCE_SCORE_{—}3A-III, RELEVANCE_SCORE_{—}3A-III, RELEVANCE_SCORE_{—}3B-I, RELEVANCE_SCORE_{—}3B-II, RELEVANCE_SCORE_{—}3C, RELEVANCE_SCORE_{—}3D) are calculated a cumulative relevance score in blocks S900 as depicted in FIG. 9.

Specifically, RELVANCE may be calculated in block S902 as a function of RELEVANCE_SCORE_{—}1, RELEVANCE_SCORE_{—}2, RELEVANCE_SCORE_{—}3A-I, RELEVANCE_SCORE_{—}3A-II, RELEVANCE_SCORE_{—}3A-III, RELEVANCE_SCORE_{—}3A-III, RELEVANCE_SCORE_{—}3B-I, RELEVANCE_SCORE_{—}3B-II, RELEVANCE_SCORE_{—}3C and RELEVANCE_SCORE_{—}3D.

For example, a total relevance score, RELEVANCE may be calculated as

RELEVANCE_SCORE_{—}1 OR

−RELEVANCE_SCORE_{—}2 OR

−(RELEVANCE_SCORE_{—}3A-I*NOUNOVERLAPWEIGHTING)+(RELEVANCE_SCORE_{—}3A-II*VERBOVERLAPWEIGHTING)+(RELEVANCE_SCORE_{—}3A-IlI*ADJOVERLAPWE1GHTING)+(RELEVANCE_SCORE_{—}3A-IV*WORDOVERLAPWEIGHTING)+(RELEVANCE_SCORE_{—}3B-I*QUERYSTRINGPRESENTOVERLAPWEIGHTING)+(RELEVANCE_SCORE_{—}3B-II*QUERYSTRINGOVERLAPWEIGHTING)+(RELEVANCE_SCORE_{—}3C*CATEGORYOVERLAPWEIGHTING)+(RELEVANCE_SCORE_{—}3D*ENTITYOVERLAPWEIGHTING).

The values NOUNOVERLAPWEIGHTING, VERBOVERLAPWEIGHTING, ADJOVERLAPWEIGHTING, WORDOVERLAPWEIGHTING, QUERYSTRINGPRESENTOVERLAPWEIGHTING, CATEGORYOVERLAPWEIGHTING, ENTITYOVERLAPWEIGHTING may be chosen constants. Example values are as follows: WORDOVERLAPWEIGHTING=10; NOUNOVERLAPWEIGHTING=5; VERBOVERLAPWEIGHTING=5; ADJOVERLAPWEIGHTING=5; QUERYSTRINGPRESENTOVERLAPWEIGHTING=25; CATEGORYOVERLAPWEIGHTING=10; ENTITYOVERLAPWEIGHTING=5.

If the score falls below a threshold (e.g. RELEVANCE<THRESHOLD) as determined in S904, the query and response may be flagged in block S906 and presented to an administrator or user, signifying that the match produced in blocks S500 may not be relevant. An administrator may then investigate, and/or modify the query and the response to possibly modify the Boolean expression (BOOL associated with the response in database 30, if necessary.

As will be appreciated, relevance assessment of responses may not be done in real time, but may be performed after a response has been presented to an end-user.

As will be appreciated, while the organization of hardware, software and data have been explicitly illustrated, a person skilled in the art will appreciate that the invention may be embodied in a large number of ways. For example, software could be formed using any number of languages, components and the like. The interface need not be provided in HTML. Instead the interface could be provided using Java, XML, or the like. Database 30 could be replaced with an object oriented structure. Queries need not be processed over a network, but could be processed at a single, suitably adapted, machine.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A computer implemented method of providing a response to a user comprising:
storing a plurality of possible responses;
storing a plurality of Boolean expressions, one of said plurality of Boolean expressions associated with each of said plurality of possible responses, each of said plurality of Boolean expressions identifying at least one condition to be satisfied by a text query, to which its associated one of said plurality of responses is to be provided;
receiving a text query; for each of said plurality of possible responses, applying its associated Boolean expression to said received text query thereby
determining if the associated Boolean expression is satisfied by said text query; presenting at least one of said plurality of possible responses, in response to said determining; and
comparing text of said query to the text of said at least one response to determine a measure of relevance of said at least one response.

2. The method of claim 1, further comprising flagging said at least one response and said query if said measure of relevance falls below a threshold.

3. The method of claim 1, wherein said comparing text of said query to the text of said at least one response, comprises comparing a title of said response to said query.

4. The method of claim 1, wherein said comparing text of said query to the text of said at least one response, comprises comparing each word in said title of said response to each word in said query.

5. The method of claim 1, wherein said comparing text of said query to the text of said at least one response, comprises comparing synonyms of words in said title of said response to each word in said query.

6. The method of claim 1, wherein said comparing text of said query to the text of said at least one response, comprises comparing parts of speech of each word in said title of said response to each word in said query.

7. The method of claim 1, wherein said comparing text of said query to the text of said at least one response, comprises comparing each word in said response to each word in said query, and counting the number of matches.

8. The method of claim 1, wherein said comparing text of said query to the text of said at least one response, comprises comparing synonyms of words in said response to each word in said query.

9. The method of claim 1, wherein said comparing text of said query to the text of said at least one response, comprises comparing semantic categories of words or phrases in said response to semantic categories of words and phrases in said query.

10. The method of claim 1, wherein said measure of relevance is determined by comparing said query to a title of said response.

11. The method of claim 1, wherein said measure of relevance is a numerical score calculated from a count of
the number of words in a title for said response and said query that have the same meaning;

12. The method of claim 1, wherein said measure of relevance is a numerical score calculated from a count of at least one of
the number of words in said response and said query that have the same meaning;
the number of two word groups in said response and said query that are the same;
the number of words or phrases in said title of said response and said query that are in the same semantic categories.

13. The method of claim 2, wherein each of said plurality of Boolean expressions comprises an expression to match a plurality of words within said text query.

14. The method of claim 13, further comprising modifying a Boolean expression associated with said at least one response as consequence of said at least one response being flagged.

15. Computer readable storage medium, storing computer executable software, that when loaded at a computing device in communication with a stored plurality of responses, and a plurality of Boolean expression each associated with one of said responses and to be satisfied by an appropriate query for an associated response, adapt said computing device to:
store a plurality of possible responses;
storing a plurality of Boolean expressions, one of said plurality of Boolean expressions associated with each of said plurality of possible responses, each of said plurality of Boolean expressions identifying at least one condition to be satisfied by a text query, to which its associated one of said plurality of responses is to be provided;
receive a text query; for each of said plurality of possible responses, applying its associated Boolean expression to said received text query thereby determining if the associated Boolean expression is satisfied by said text query;
present at least one of said plurality of possible responses, in response to said determining, and
compare text of said query to the text of said at least one response to determine a measure of relevance of said at least one response.
